(19) United States
(12) Patent Application Publication
(10) Pub. No.: US 2013/0229788 A1
(43) Pub. Date: Sep. 5, 2013

(54) ILLUMINATION DEVICE FOR A COOKING HOB WITH A GLASS CERAMIC PANEL

(71) Applicants: Harald Hoffmann, Rothenburg o. d. Tauber (DE); Claus Meider, Wallhausen (DE); Jochen Holzinger, Rothenburg o. d. Tauber (DE)

(72) Inventors: Harald Hoffmann, Rothenburg o. d. Tauber (DE); Claus Meider, Wallhausen (DE); Jochen Holzinger, Rothenburg o. d. Tauber (DE)

(73) Assignee: ELECTROLUX HOME PRODUCTS CORPORATION N.V., Brussels (BE)

(21) Appl. No.: 13/884,349

(22) PCT Filed: Nov. 25, 2011
(86) PCT No.: PCT/EP11/71013

§ 371 Date: May 9, 2013

(30) Foreign Application Priority Data
Nov. 26, 2010 (EP) 10015017.6

(51) Int. Cl. F21V 33/00; F21V 13/04

(52) U.S. Cl. CPC F21V 33/0044; F21V 13/04
USPC 362/92; 362/308; 362/253

(57) ABSTRACT

The present invention relates to an illumination device for a cooking hob with a glass ceramic panel. The illumination device includes a funnel-shaped reflector (10) with an upper open side and a lower open side. The illumination device includes at least one light source (36) arranged or arrangable at the lower open side and a transparent cover element (14) arranged or arrangable at the upper open side of the reflector (10). The illumination device includes at least one diffuser screen (16) arranged or arrangable between the light source (36) and the cover element (14). The diffuser screen (16) is made of a semitransparent material. The cross-section of the diffuser screen (16) is smaller than the cross-section of the reflector (10) enclosing said diffuser screen (16), so that lateral light beams (52) from the light source (36) to the cover element (14) can pass the diffuser screen (16). Further, the present invention relates to a cooking hob with a glass ceramic panel and at least one illumination device.

The present invention relates to an illumination device for a cooking hob with a glass ceramic panel according to claim 1. Further, the present invention relates to a cooking hob with a glass ceramic panel and at least one illumination device according to claim 14.

The cooking zone, the switches and the displays on a glass ceramic panel of a cooking hob are typically indicated by printed symbols. It would be especially aesthetic, if the indicating symbols would vanish in the switch-off state of the cooking hob.

This can be realized be electrically illuminated cooking zones, switches and displays on the glass ceramic panel of the cooking hob. However, there are usually non-uniform illuminations and spots on the glass ceramic panel.

It is an object of the present invention to provide an illumination device, which allows uniform illuminations of the object on the glass ceramic panel.

The object of the present invention is achieved by the illumination device according to claim 1.

According to the present invention an illumination device is provided for a cooking hob with a glass ceramic panel, wherein:
the illumination device includes a funnel-shaped reflector with an upper open side and a lower open side,
the illumination device includes at least one light source arranged or arrangable at the lower open side,
the illumination device includes a transparent cover element arranged or arrangable at the upper open side of the reflector,
the illumination device includes at least one diffuser screen arranged or arrangable between the light source and the cover element,
the diffuser screen is made of a semitransparent material, and
the cross-section of the diffuser screen is smaller than the cross-section of the reflector enclosing said diffuser screen, so that lateral light beams from the light source to the cover element can pass the diffuser screen.

The main idea of the present invention is the arrangement of the components of the illumination device. In particular, the diffuser screen, which is smaller than the reflector, allows that the lateral light beams pass said diffuser screen and propagate directly from the light source to the cover element. In contrast, central light beams are scattered by the diffuser screen, so that the intensity in the central portion is reduced. This results in a uniform intensity distribution of the light on the cover element.

According to a preferred embodiment of the present invention a circuit board is arranged or arrangable at the lower open side of the reflector, wherein the light source is attached on said circuit board.

Preferably, the reflector is made of plastics. The inner side of the reflector may be coated by reflective material.

For example, the diffuser screen is made of polycarbonate. This

In particular, the cover element is made of silicone.

According to the preferred embodiment of the present invention the light source includes a number of light emitting diodes.

Further, the reflector may comprise snap-fits at its lower side for fastening the circuit board. The reflector and the snap-fits may be formed as a single-piece part, so that the fastening of the circuit board may be performed without any tools and further fastening means.

Additionally, the reflector may comprise means for aligning the diffuser screen in its central portion. The reflector and the means for aligning the diffuser screen may also be formed as a single-piece part.

Moreover, the reflector may comprise snap-fits in its interior for fastening the diffuser screen.

The reflector may comprise latch elements engaged or engageable with corresponding sleeve elements of the cover element in order to fasten said cover element at the reflector.

Further, the cover element may comprise a hollow for receiving at least one temperature sensor.

Preferably, the illumination device may comprise a heat conducting element providing a heat transfer from a cooking zone of the cooking hob to the temperature sensor.

In particular, the illumination device is provided for indicating a corresponding cooking zone of the cooking hob.

Further, the present invention relates to a cooking hob with a glass ceramic panel and at least one illumination device described above.

In particular, the cooking hob is an induction cooking hob and the illumination device is arranged in the centre of a corresponding induction coil.

Novel and inventive features of the present invention are set forth in the appended claims.

The present invention will be described in further detail with reference to the drawings, in which

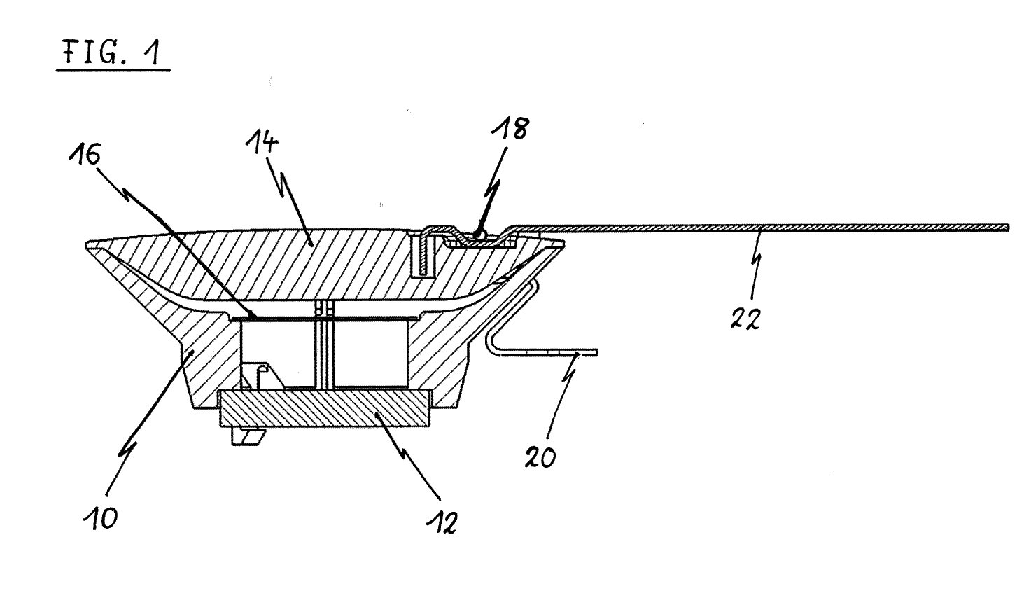

FIG. 1 illustrates a sectional side view of an illumination device for a cooking hob according to a preferred embodiment of the present invention,

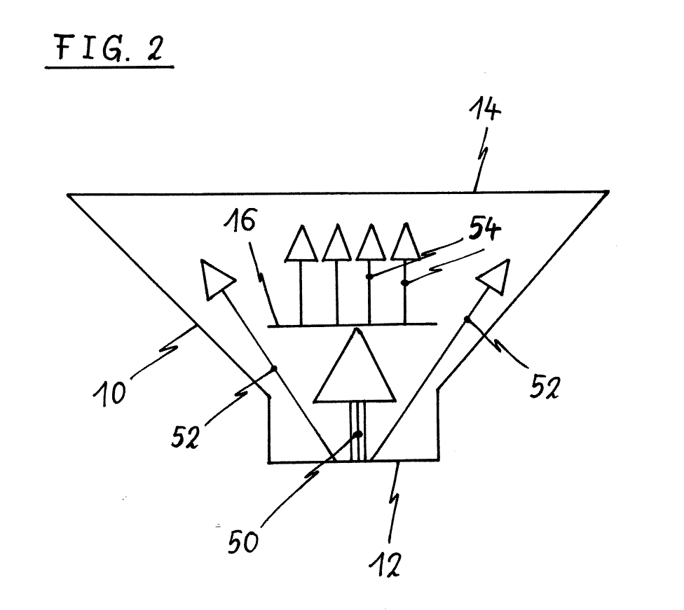

FIG. 2 illustrates a schematic sectional side view of the light propagation within the illumination device according to the preferred embodiment of the present invention,

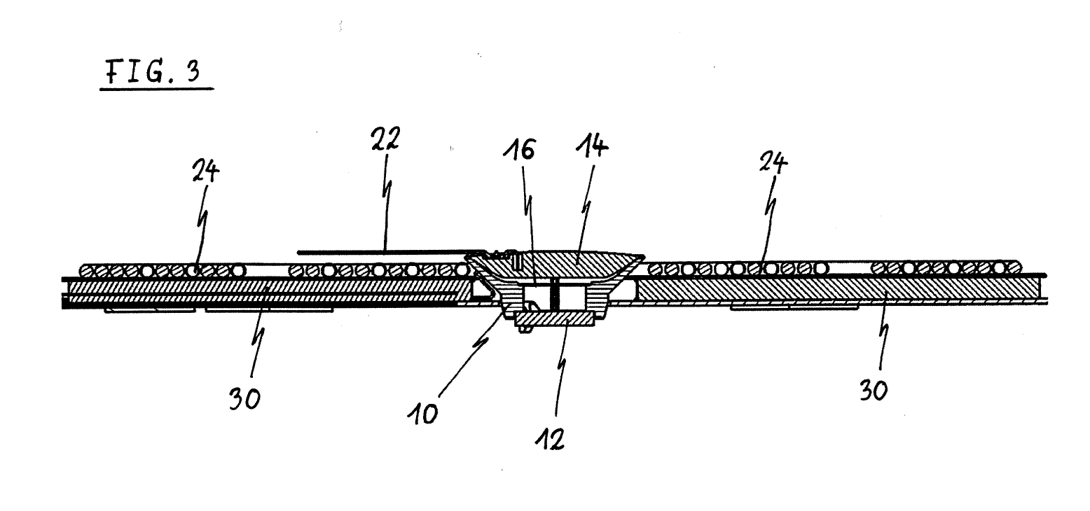

FIG. 3 illustrates a sectional side view of the illumination device mounted within the cooking hob according to the preferred embodiment of the present invention,

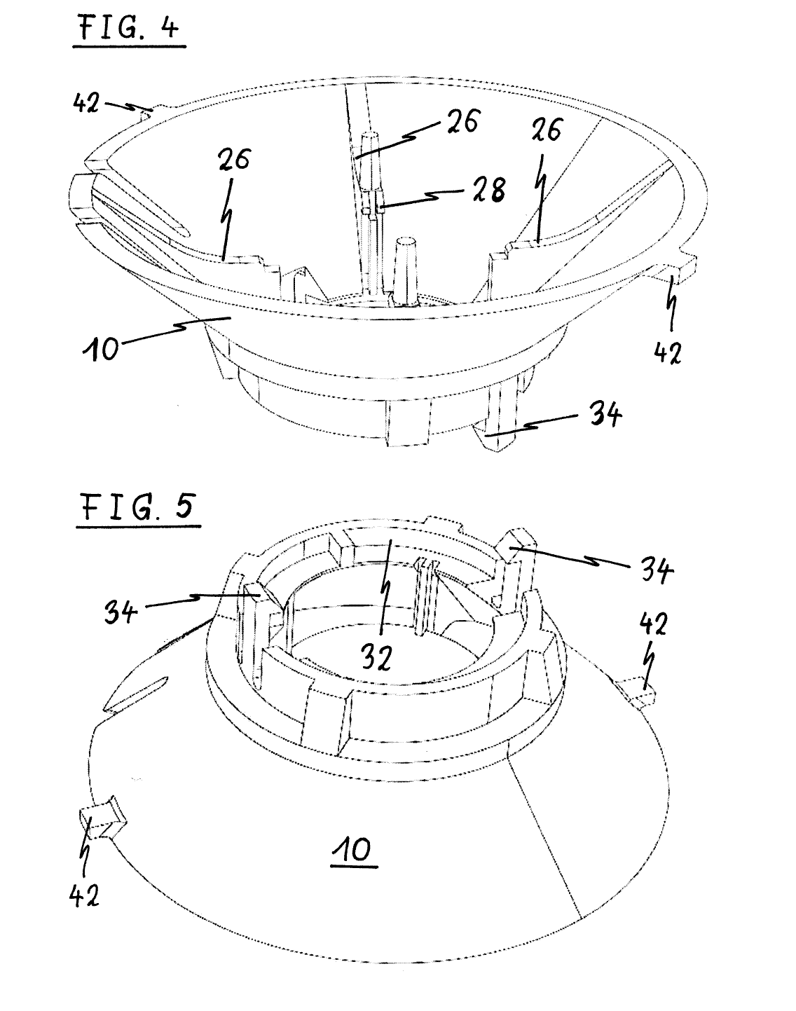

FIG. 4 illustrates a perspective view of a reflector of the illumination device according to the preferred embodiment of the present invention,

FIG. 5 illustrates a perspective view of the inverted reflector of the illumination device according to the preferred embodiment of the present invention,

FIG. 6 illustrates a perspective view of the reflector of the illumination device with an inserted diffuser screen according to the preferred embodiment of the present invention,

FIG. 7 illustrates a perspective view of the diffuser screen according to the preferred embodiment of the present invention,

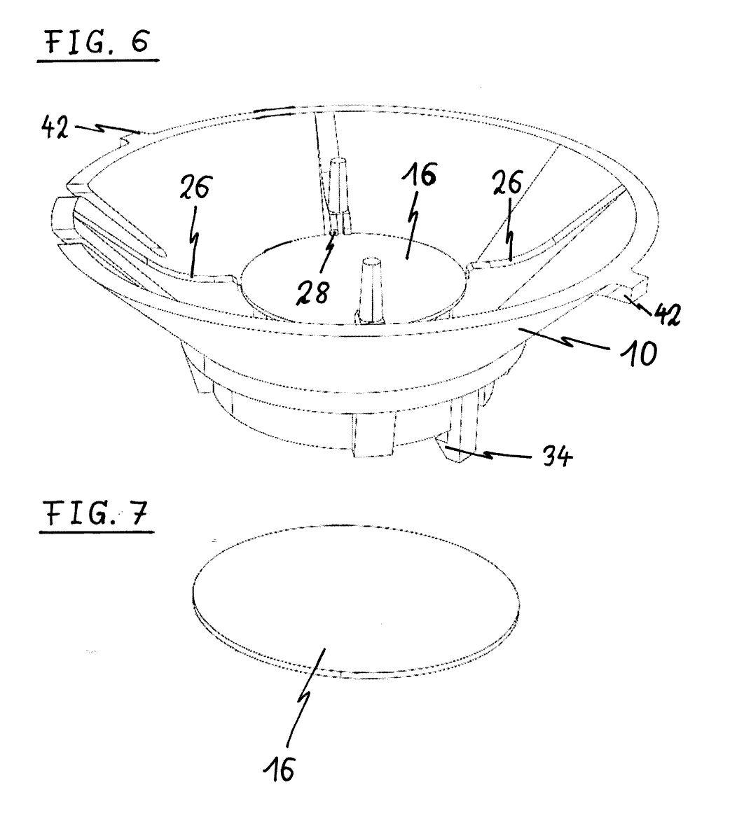

FIG. 8 illustrates a perspective view of the inverted reflector of the illumination device with an inserted circuit board according to the preferred embodiment of the present invention,

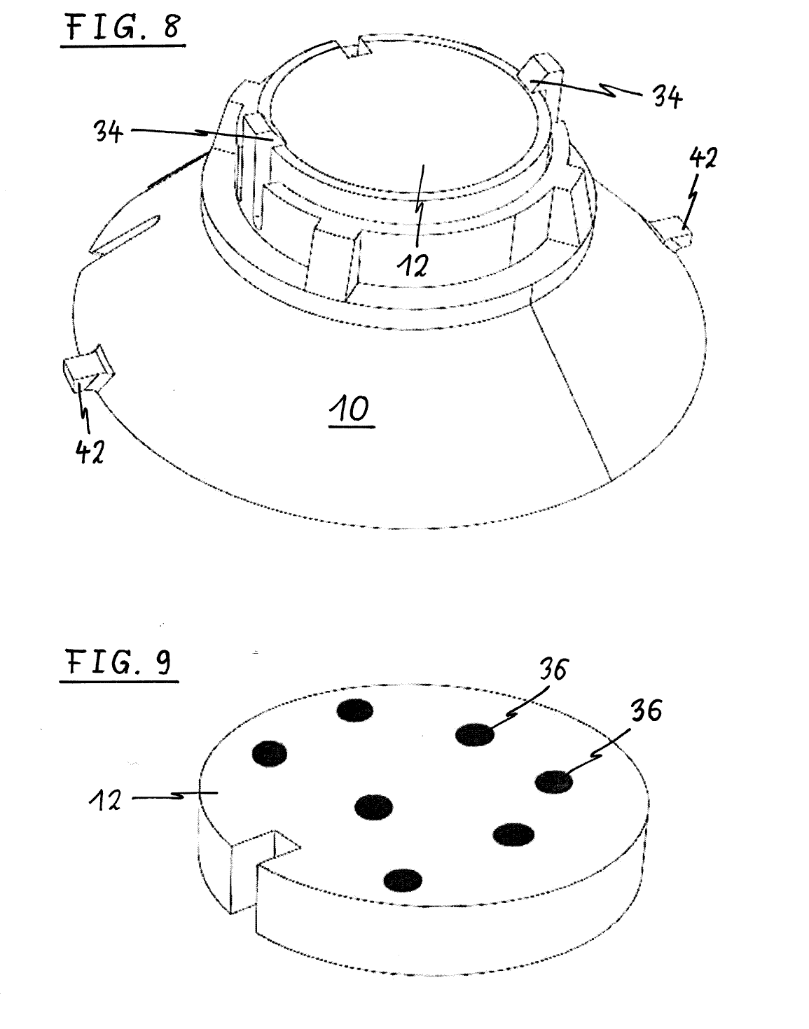

FIG. 9 illustrates a perspective view of the circuit board for the illumination device according to the preferred embodiment of the present invention,

FIG. 10 illustrates a perspective view of a cover element for the illumination device according to the preferred embodiment of the present invention,

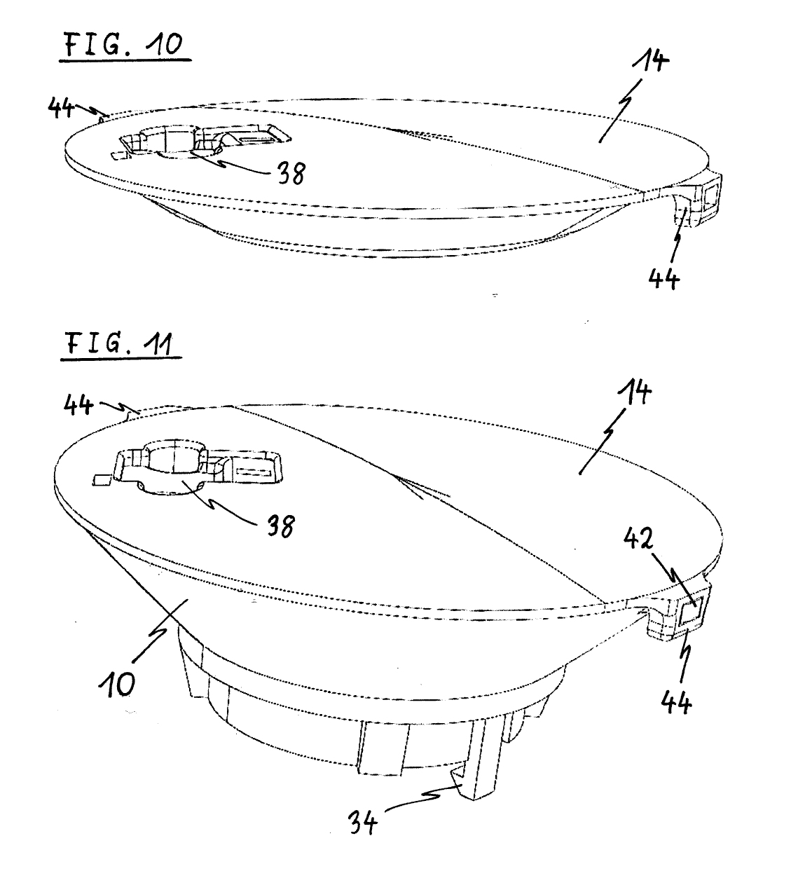

FIG. 11 illustrates a perspective view of the reflector of the illumination device with the fitted cover element according to the preferred embodiment of the present invention,

FIG. 12 illustrates a perspective view of a heat conducting element for the illumination device according to the preferred embodiment of the present invention,

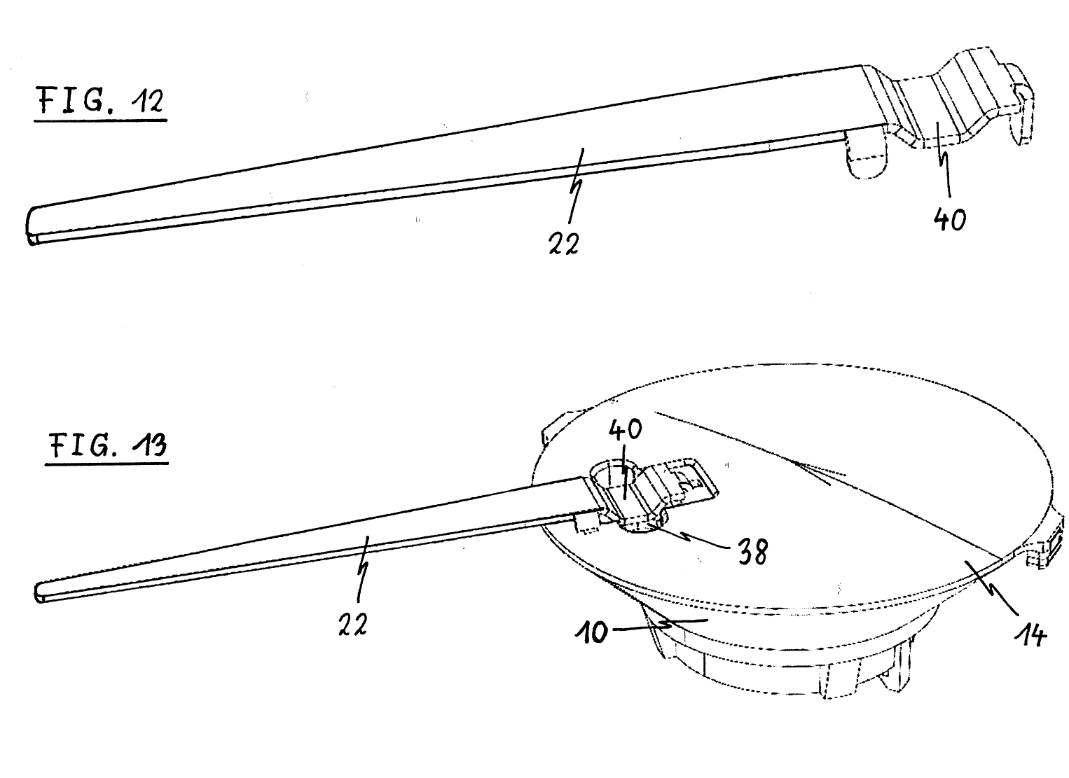

FIG. 13 illustrates a perspective view of the reflector of the illumination device with the fitted cover element and heat conducting element according to the preferred embodiment of the present invention,

FIG. 14 illustrates a perspective view of the illumination device with the heat conducting element and a temperature sensor according to the preferred embodiment of the present invention,

FIG. 15 illustrates a perspective view of the reflector with the diffuser screen and the temperature sensor according to the preferred embodiment of the present invention, and

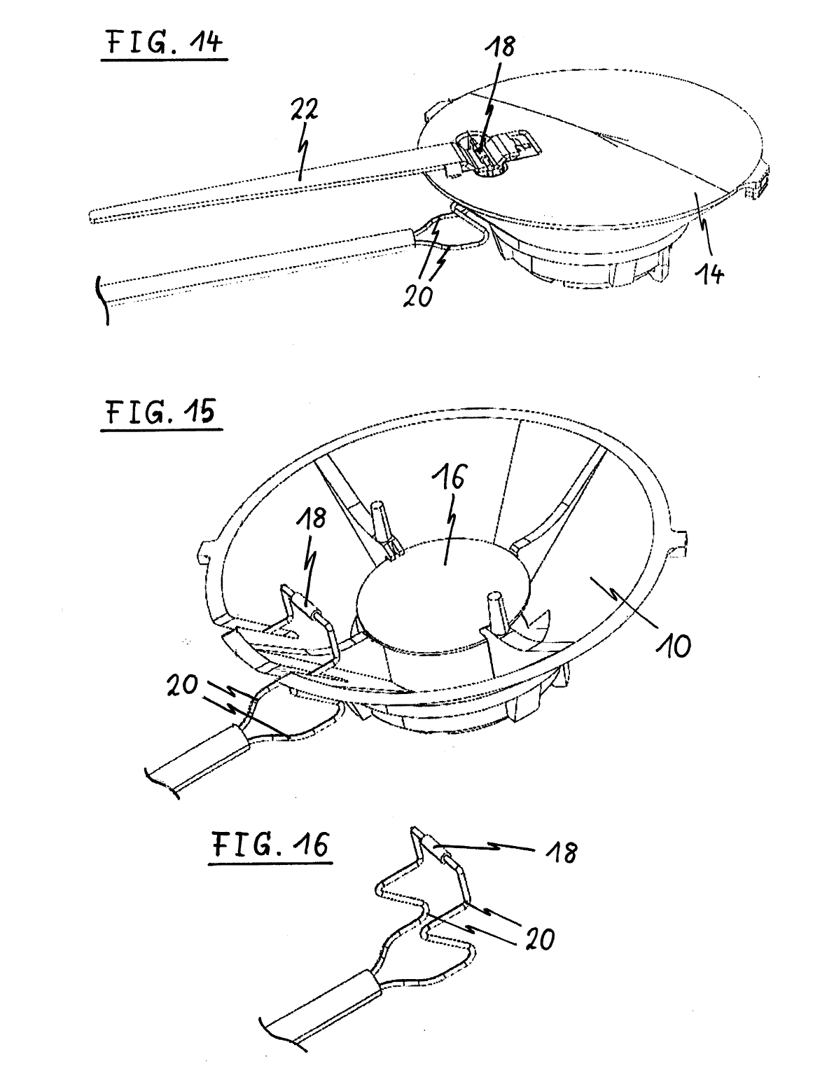

FIG. 16 illustrates a perspective view of the temperature sensor with a cable according to the preferred embodiment of the present invention.

FIG. 1 illustrates a sectional side view of an illumination device for a cooking hob according to a preferred embodiment of the present invention. The illumination device is arrangable below a glass ceramics panel of the cooking hob.

The illumination device includes a reflector 10, a circuit board 12, a cover element 14 and a diffuser screen 16. The reflector 10 is funnel-shaped and made of plastic. The plastic is opaque. Alternatively, the inner side of the reflector 10 is coated by a reflective material. The diffuser screen 16 is made of a semi-transparent material. In particular, the diffuser screen 16 is made of polycarbonate. The cover element 14 is made of a transparent material. For example, the cover element 14 is made of silicone. The circuit board 12 is arranged in the bottom of the reflector 10 and comprises one or more light sources.

Further, the illumination device includes a temperature sensor 18, a cable pair 20 and an elongated heat conducting element 22.

FIG. 2 illustrates a schematic sectional side view of the light propagation within the illumination device according to the preferred embodiment of the present invention.

A central light beam 50 extends upwards form the circuit board 12 to the diffuser screen 16. Lateral light beams 52 extend upward to the cover element 14. The lateral light beams 52 pass by the diffuser screen 16, so that the lateral light beams 52 reach directly the cover element 14.

The central light beam 50 is scattered by the diffuser screen 16, so that diffuse light beams 54 extend upward from diffuser screen 16 to the cover element 14. The diffuser screen 16 allows a uniform intensity distribution of the light on the cover element 14.

If the diffuser screen 16 would be absent, then the intensity distribution of the light would have a maximum in the centre of the cover element 14.

FIG. 3 illustrates a sectional side view of the illumination device mounted within the cooking hob according to the preferred embodiment of the present invention.

In this example, the illumination device is arranged in the centre of an induction coil 24. Thus, the illumination device indicates the positions of the induction coil 24 and the corresponding cooking zone within the cooking hob. The induction coil 24 is arranged upon a base layer 30 of the cooking hob.

The heat conducting element 22 extends horizontally above the induction coil 24, so that the effective temperature on the cooking zone occurs also at the temperature sensor 18.

FIG. 4 illustrates a perspective view of the reflector 14 of the illumination device according to the preferred embodiment of the present invention. The reflector 10 is funnel-shaped and comprises inside a number of vertical fins 26. In this example, the reflector 10 comprises four vertical fins 26.

The fins 26 are provided for supporting the diffuser screen 16 in the centre of the reflector 10, so the lateral light beams 52 can pass by said diffuser screen 16. Two opposite fins 26 includes a snap-fit 28 in each case in order to fasten the diffuser screen 16.

Two latch elements 42 are arranged at the upper border of the reflector 10. The latch elements 42 are provided for fastening the cover element 14. The latch elements 42 are arranged at opposite sides of the upper border of the reflector 10.

FIG. 5 illustrates a perspective view of the inverted reflector 10 of the illumination device according to the preferred embodiment of the present invention.

At its bottom the reflector 10 comprises an inclusion 32 for receiving the circuit board 12. Two opposite snap-fits 34 are arm ranged on the bottom side of the reflector for fastening the circuit board 12.

FIG. 6 illustrates a perspective view of the reflector 10 of the illumination device with an inserted diffuser screen 16 according to the preferred embodiment of the present invention. FIG. 6 shows the reflector 10 from the same position as in FIG. 4. The diffuser screen 16 is inserted between the fins 26 and fixed by the snap-fits 28.

FIG. 7 illustrates a perspective view of the diffuser screen 16 according to the preferred embodiment of the present invention. FIG. 7 clarifies that the diffuser screen 16 has the form of a circular disk.

FIG. 8 illustrates a perspective view of the inverted reflector 10 of the illumination device with an inserted circuit board 12 according to the preferred embodiment of the present invention. FIG. 8 shows the reflector 10 from the same position as in FIG. 5. The circuit board 12 is inserted in the inclusion 32 and fixed by the both opposite snap-fits 34.

FIG. 9 illustrates a perspective view of the circuit board 12 for the illumination device according to the preferred embodiment of the present invention. A number of light emitting diodes 36 are arranged on the circuit board 12. In this example, the circuit board 12 comprises seven light emitting diodes 36 are arranged on the circuit board 12.

FIG. 10 illustrates a perspective view of the cover element 14 for the illumination device according to the preferred embodiment of the present invention. The cover element 14 has substantially the same cross section as the upper side of the reflector 10. In this example, the cover element 14 is made of silicone.

The cover element 14 includes two sleeve elements 44 arranged at opposite sides of said cover element 14. The sleeve elements 44 are provided for receiving the corresponding latch elements 42 of the reflector 10. The cover element 14 is fixed at the reflector 10 by the latch elements 42 and the sleeve elements 44.

Further, the cover element 14 includes a hollow 38 in its upper side. The hollow 38 is provided for receiving a corresponding curve 40 of the heat conducting element 22.

FIG. 11 illustrates a perspective view of the reflector 10 of the illumination device with the fitted cover element 14 according to the preferred embodiment of the present invention. In FIG. 11 the cover element 14 is fixed at the reflector 10. The sleeve elements 44 of the cover element 14 have received the corresponding latch elements 42 of the reflector 10.

FIG. 12 illustrates a perspective view of the heat conducting element 22 for the illumination device according to the preferred embodiment of the present invention. The heat conducting element 22 includes a curve 40 corresponding with the hollow 30 in the cover element 14. The curve 40 is provided for receiving the temperature sensor 18, and the hollow 38 is provided for receiving the curve 40. The heat conducting element 22 transfers the effective temperature on the cooking zone to the temperature sensor 18.

FIG. 13 illustrates a perspective view of the reflector 10 of the illumination device with the fitted cover element 14 and heat conducting element 22 according to the preferred embodiment of the present invention. The heat conducting element 22 is arranged at the cover element 14. The curve 40 of the heat conducting element 22 is received by the hollow 38 of the cover element 14.

FIG. 14 illustrates a perspective view of the illumination device with the heat conducting element 22 and the temperature sensor 18 according to the preferred embodiment of the present invention. FIG. 14 is similar to FIG. 13. Additionally, the temperature sensor 18 with the cable pair 20 is shown in FIG. 14. The temperature sensor 18 is arranged within the curve 40 of the heat conducting element 22 and within the hollow 38 of the cover element 14.

FIG. 15 illustrates a perspective view of the reflector 10 with the diffuser screen 16 and the temperature sensor 18 according to the preferred embodiment of the present invention. In other words, FIG. 15 shows the illumination device of FIG. 14 without the heat conducting element 22 and the cover element 14. FIG. 15 clarifies that the cable pair 20 penetrates the reflector 10.

FIG. 16 illustrates a perspective view of the temperature sensor 18 with the cable pair 20 according to the preferred embodiment of the present invention. In this example, the cable pair 20 comprises two Z-shaped portions beside the temperature sensor 18. The Z-shaped portions allow a distance between the cable pair 20 and the heat conducting element 22.

The illumination device of the present invention allows a simple installation of the illumination device itself and said illumination device within the cooking hob.

### LIST OF REFERENCE NUMERALS

10 reflector
12 circuit board
14 cover element
16 diffuser screen
18 temperature sensor
20 cable pair
22 heat conducting element
24 induction coil
26 fin
28 snap-fit
30 base layer
32 inclusion
34 snap-fit
36 light emitting diode
38 hollow
40 curve
42 latch element
44 sleeve element
50 central light beam
52 lateral light beam
54 diffuse light beams

1. An illumination device for a cooking hob with a glass ceramic panel, wherein:
the illumination device includes a funnel-shaped reflector (10) with an upper open side and a lower open side, the illumination device includes at least one light source (36) arranged or arrangable at the lower open side,
the illumination device includes a transparent cover element (14) arranged or arrangable at the upper open side of the reflector (10),
the illumination device includes at least one diffuser screen (16) arranged or arrangable between the light source (36) and the cover element (14),
the diffuser screen (16) is made of a semitransparent material, and
the cross-section of the diffuser screen (16) is smaller than the cross-section of the reflector (10) enclosing said diffuser screen (16), so that lateral light beams (52) from the light source (36) to the cover element (14) can pass the diffuser screen (16).

2. The illumination device according to claim 1, characterized in, that a circuit board (12) is arranged or arrangable at the lower open side of the reflector, wherein the light source (36) is attached on said circuit board (12).

3. The illumination device according to claim 1, characterized in, that the reflector (10) is made of plastics.

4. The illumination device according to claim 1, characterized in, that the diffuser screen (16) is made of polycarbonate.

5. The illumination device according to claim 1, characterized in, that the cover element (14) is made of silicone.

6. The illumination device according to claim 1, characterized in, that the light source includes a number of light emitting diodes (36) .

7. The illumination device according to claim 2, characterized in, that the reflector (15) comprises snap-fits (34) at its lower side for fastening the circuit board (12).

8. The illumination device according to claim 1, characterized in, that the reflector (15) comprises means (36) for aligning the diffuser screen (16) in its central portion.

9. The illumination device according to claim 1, characterized in, that the reflector (15) comprises snap-fits (34) in its interior for fastening the diffuser screen (16).

10. The illumination device according to claim 1, characterized in, that the reflector (15) comprises latch elements (42) engaged or engageable with corresponding sleeve elements (44) the cover element (14) in order to fasten said cover element (14) at the reflector (10) .

11. The illumination device according to claim 1, characterized in, that the cover element (14) comprises a hollow (38) for receiving at least one temperature sensor (18).

12. The illumination device according to claim 11, characterized in, that the illumination device comprises a heat conducting element (22) providing a heat transfer from a cooking zone of the cooking hob to the temperature sensor (18).

13. The illumination device according to claim 1, characterized in, that the illumination device is provided for indicating a corresponding cooking zone of the cooking hob.

14. A cooking hob with a glass ceramic panel, characterized in, that the cooking hob comprises at least one illumination device according to claim 1.

15. The cooking hob according to claim 14, characterized in, that the cooking hob is an induction cooking hob and the illumination device is arranged in the centre of a corresponding induction coil (24).
